(19) United States
(12) Patent Application Publication
(10) Pub. No.: US 2010/0118111 A1
(43) Pub. Date: May 13, 2010

(54) METHOD AND APPARATUS FOR REMOTE CAMERA CONTROL INDICATIONS IN VIDEO CONFERENCING

(75) Inventor: Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/268,351

(22) Filed: Nov. 10, 2008

(51) Int. Cl. H04N 7/15

(52) U.S. Cl. 348/14.08; 348/E07.083

(57) ABSTRACT

Systems and methods for indicating camera control operations to a remote party during a video conference session are provided. An interface is provided to a receiving party (receiving a video stream), allowing the receiving party to input any desired camera control indications to be sent to a sending party (sending a video stream). Signaling of camera control indications from the party receiving the video stream may be performed in-band together with a video stream itself, where the camera control indications are sent with Real-Time Control Protocol (RTCP) receiver reports or within a RTCP packet dedicated to transmitting camera control indications. Moreover, camera control indications received by the sending party may be rendered and converted into visual or audio signals, vibrations, etc. that are displayed to one or more video conferencing session participants, such as the sending party.

### FIELD OF THE INVENTION

Various embodiments relate generally to video conferencing in a packet-based network environment. More specifically, various embodiments relate to providing an interface for inputting desired camera control indications (CCI), where in-band signaling is utilized to transport the CCIs with a video stream itself, and received CCIs are rendered into one or more types of signs or indicia for a video conference session participant.

### BACKGROUND OF THE INVENTION

This section is intended to provide a background or context to various embodiments recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video conferencing applications enjoy significant popularity among personal computer (PC) and mobile device users. Video conferencing can allow for a richer communication session between distant/remote users when compared to, for example, voice-only Voice over Internet Protocol (VoIP) or telephony calls. Moreover, a tendency towards Internet Protocol (IP)-based packet switched video conferencing services can be seen, e.g., with the 3rd Generation Partnership Project (3GPP) standardization of two different services for video conferencing. One such 3GPP standard is referred to as TS 26.236, Packet Switched Conversational multimedia applications (PSC). Another 3GPP video conferencing standard is referred to as TS 26.114, IP Multimedia Subsystem, Multimedia Telephony (MTSI).

Both of the above-standardized services make use of the Session Initiation Protocol (SIP) for call setup and control. SIP is a textual protocol that defines a set of messages between the end parties of a call, as well as with intermediate network nodes (e.g., registrar servers, SIP proxy servers, etc.) Upon successful setup of a session, data exchange between User Agent Clients (UACs) begins according to negotiated media descriptions in an offer/answer dialogue during the session setup.

In video conferencing applications, the codecs which are utilized and their modes are negotiated during a session setup, e.g., with SIP as described above. Among other things, SIP conveys messages according to the session description protocol (SDP) offer/answer model. An offer/answer negotiation begins with an initial offer being generated by one of the endpoints referred to as the offerer, and including an SDP description. Another endpoint, an answerer, responds to the initial offer with an answer that also includes an SDP description. Both the offer and the answer include a direction attribute indicating whether the endpoint desires to receive media, send media, or both.

The semantics included for the media type parameters may depend on a direction attribute. In general, there are two categories of media type parameters. First, capability parameters describe the limits of the stream that the sender is capable of producing or the receiver is capable of consuming, when the direction attribute indicates reception only or when the direction attribute includes sending, respectively. Certain capability parameters, such as the level specified in many video coding formats, may have an implicit order in their values that allows the sender to downgrade the parameter value to a minimum that all recipients can accept. Second, certain media type parameters are used to indicate the properties of the stream that are going to be sent. As the SDP offer/answer mechanism does not provide a way to negotiate stream properties, it is advisable to include multiple options of stream properties in the session description or conclude the receiver acceptance for the stream properties in advance.

The Real-time Transport Protocol (RTP) (described in H. Schulzrinne, S. Casner, S., R. Frederick, and V. Jacobson, “RTP: A Transport Protocol for Real-Time Applications”, IETF STD 64, RFC 3550, July 2003, and available at http://www.ietf.org/rfc/rfc3550.txt) is generally used for transmitting continuous and/or real-time data, such as a real-time video feed captured by a web cam or a mobile device in networks based on IP. The Real-Time Control Protocol (RTCP) is a compound protocol to RTP. RTCP allows for the monitoring and the exchange of statistics about the quality of a session. RTCP also serves other purposes, such as conveying information about participants in an on-going session, e.g., unique identification of a participant, synchronization, and signalling that a participant is leaving a session. RTP and RTCP are generally conveyed over the User Datagram Protocol (UDP), which in turn, is conveyed over IP.

RTP and RTCP are designed for sessions that range from one-to-one communication to large multicast groups of thousands of endpoints. In order to control the total bitrate caused by RTCP packets in a multiparty session, the transmission interval of RTCP packets transmitted by a single endpoint is proportional to the number of participants in the session. Each media coding format has a specific RTP payload format, which specifies how media data is structured in the payload of an RTP packet.

RTCP utilizes various types of messages and a plurality of corresponding packet types, one being a RTCP sender report/RTCP sender report packet type. The RTCP sender report is sent periodically by active senders in a conference to report transmission and reception statistics for all RTP packets sent during an interval. The RTCP sender report includes an absolute timestamp, which allows a receiver to synchronize different RTP messages. Another type of RTCP message is the RTCP receiver report, with its corresponding RTCP receiver report packet type. The receiver report can be utilized for passive participants, e.g., those that do not send RTP packets. The receiver report informs the sender and other receivers about the quality of service of a session.

Signaling refers to the information exchange concerning the establishment and control of a connection and the management of the network, in contrast to user-plane information transfer, such as real-time media transfer. In-band signaling refers to the exchange of signaling information within the same channel or connection that user-plane information, such as real-time media, uses. Out-of-band signaling is done on a channel or connection that is separate from the channels used for the user-plane information, such as real-time media.

In certain video conferencing scenarios, problems involving the positioning and calibrating of a camera can arise, which may impact the video conferencing experience. For example, as a video stream is being transmitted to a remote party, it is not always possible for the sending party to meet the expectations of the receiving party. As a consequence, the receiving party often needs to indicate one or more camera configuration parameters using voice commands to the sending party. This can be annoying and disruptive for all participants of the video conference and can result in valuable session time being lost.

An example of a conventional video conferencing system is described in International Patent Publication No. WO 94/07327, “Method and Apparatus for On-Screen Camera Control in Video-Conference Equipment,” which enables control with a pointing device, such as a mouse. Several other related patents and patent applications also exist which describe handling the control of a remote motorized camera. In such conventional systems and methods, indications are captured by the controlling device and transmitted, out-of-band, to a unit that controls a remote motorized camera.

Conventional video conferencing systems, such as those described above, generally operate under two assumptions. The first assumption is that a remote camera is motorized. However, in mobile video conferencing systems, where most or all of the participants are utilizing a mobile device, this is often not the case. The second assumption generally made in conventional video conferencing systems follows from the first assumption that a remote camera is motorized. That is, based on the first assumption, the control commands are assumed to be sent out-of-band (of the video stream) because these control commands are being directed to a different control entity—the motorized remote camera. Such an assumption has an impact on video conferencing setup and control.

### SUMMARY OF THE INVENTION

Various embodiments are described herein for enabling systems and methods of indicating camera control operations to a remote party during a video conference session. An interface is provided to a receiving party (receiving a video stream), allowing the receiving party to input any desired camera control indications to be sent to a sending party (sending the video stream). Signaling of camera control indications from the party receiving the video stream may be performed in-band together with a video stream itself, where the camera control indications are sent with RTCP receiver reports. Moreover, camera control indications received by the sending party may be rendered and converted into visual or audio signals, vibrations, etc. that are displayed or presented to one or more video conferencing session participants, such as the sending party.

One exemplary embodiment relates to a method for indicating camera control operations to a remote party during a video conference session The method includes participating in an offer and answer negotiation indicating proposed camera control indication usage in a video conference. Parameters associated with a camera control indication are indicated in at least one packet. Furthermore, at least one packet in-band with a video stream to be controlled by the camera control indication is signaled.

Another exemplary embodiment relates to an apparatus, comprising an electronic device. The apparatus is configured to participate in an offer and answer negotiation indicating proposed camera control indication usage in a video conference. The apparatus is further configured to indicate parameters associated with a camera control indication in at least one packet. Further still, the apparatus is configured to signal the at least one packet in-band with a video stream to be controlled by the camera control indication.

Yet another exemplary embodiment relates to a method for receiving camera control operations. The method includes receiving a camera control indication request signaled in-band with a video stream of a video conference to be controlled by a camera control indication indicated within the camera control indication request. The method further includes confirming receipt of the camera control indication request, and rendering the received camera control indication.

Still another exemplary embodiment relates to another apparatus comprising an electronic device configured to receive a camera control indication request signaled in-band with a video stream of a video conference to be controlled by a camera control indication indicated within the camera control indication request. The apparatus is further configured to confirm receipt of the camera control indication request, and to render the received camera control indication.

Other exemplary embodiments relate to computer program products, embodied on computer readable media, as well as apparatuses comprising means for performing the processes described for indicating camera control operations to a remote party during a video conference session, and for performing the processes described for receiving camera control operations during a video conference session.

Various embodiments disclosed herein describe a system and method for communicating camera control indications to a remote party of a video conference in an efficient manner. Moreover, the input of the camera control indication requests as well as its rendering on, e.g., a mobile device, of the remote party are transparent to the video conference session and do not “disturb” other session participants.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 illustrates the format of a camera control indication RTCP APP report block in accordance with various embodiments;

FIG. 2 illustrates exemplary implementations of rendered camera control indications in accordance with various embodiments;

FIG. 3 is a flow chart illustrating processes performed to indicate camera control operations to a remote party in a video conference session in accordance with various embodiments;

FIG. 4 is a flow chart illustrating processes performed in a delay protection procedure in accordance with various embodiments;

FIG. 5 is a flow chart illustrating processes performed when receiving camera control operations in accordance with various embodiments;

FIG. 6 illustrates an exemplary camera control indication message exchange during a video conference scenario in accordance with various embodiments;

FIG. 7 is an overview diagram of a system within which various embodiments may be implemented;

FIG. 8 is a perspective view of an electronic device that can be used in conjunction with the implementation of various embodiments; and

FIG. 9 is a schematic representation of the circuitry which may be included in the electronic device of FIG. 8.

### DETAILED DESCRIPTION OF VARIOUS EMBODIMENTS

Various embodiments provide systems and methods of indicating camera control operations to a remote party in a video conference session. In accordance with one embodiment, an interface is provided to a receiving party (receiving a video stream), thus allowing the receiving party to input any desired camera control indications to be sent to a sending party (sending the video stream). Additionally, signaling of camera control indications from the party receiving the video stream may be performed in-band together with a video stream itself. Moreover, camera control indications received by the sending party may be converted into visual or audio signals, vibrations, etc. that are displayed or other wise presented to one or more video conferencing session participants, such as the sending party.

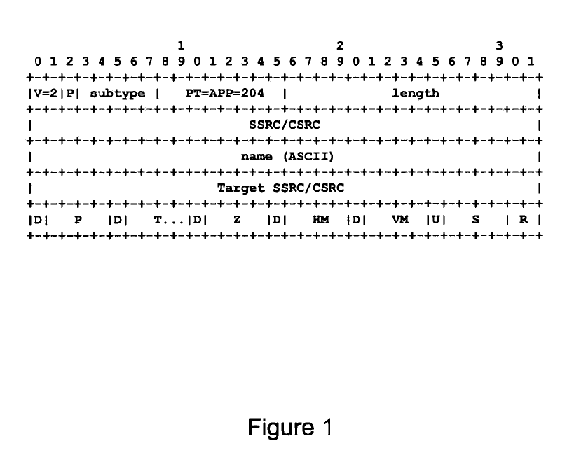

As described above, camera control indications can be signaled in-band within the same video session stream that is being controlled via the camera control indications. For this purpose, an application-defined RTCP packet (APP) report block is defined in accordance with various embodiments. The newly defined RTCP APP report block may be referred to as, e.g., Camera Control Indication (CCI). The CCI APP report block may have a format such as that shown in FIG. 1. It should be noted that the first three rows (or 12 bytes) are commensurate with that of a generic APP packet.

That is and referring to FIG. 1, a “V” field is indicative of the version of RTP, which is the same in RTCP packets as in RTP pages (in this example, 2). A “P” field represents padding, where setting the padding field indicates that the RTCP packet contains some additional padding octets at the end which are not part of control information. Padding may be needed by some encryption algorithms with fixed block sizes. A “subtype” field may be used as a subtype for allowing a particular set of APP packets to be defined under a unique name or for any application-dependant data. A “length” field indicates the length of the packet. A “name” field indicates a name chosen by the party defining the set of APP packets to be unique with respect to other APP packets an application may receive, where the name is interpreted as a sequence of four American Standard Code for Information Interchange (ASCII) characters.

An “SSRC/CSRC” field in a generic APP packet refers to either a synchronization source identifier or contributing source identifier for the originator of the packet. Here and in accordance with various embodiments, a “Target SSRC/CSRC” field is used to indicate a participant to whom the present command is directed, and is useful when a video conferencing session has multiple participants.

Various parameters associated with a CCI request are captured and indicated in one or more fields in the CCI APP report block. “D” fields are used to indicate a direction applicable to a following operation, the semantics of which depend on a corresponding camera control operation, while a “P” field (which is distinct from the previously described P field of the first row) indicates a panning magnitude. Thus, a D field preceding the P field indicates whether a desired camera control operation refers to a request to pan to the left (D=1) or to the right (D=0). A “T” field indicates the tilting magnitude, where the preceding D field to the T field indicates whether it is tilting to the top (D=1) or to the bottom (D=0). A “Z” field indicates the zooming magnitude, and the preceding D field indicates whether it is zooming in (D=1) or zooming out (D=0). An “HM” field indicates a horizontal motion request, and the preceding D field indicates whether it is a request to move to the left (D=1) or to the right (D=0). A “VM” field indicates a vertical motion request, where the preceding D field indicates whether it is a request to move to the top (D=1) or to the bottom (D=0). An “S” field indicates a request to perform a sharpening operation. A “U” field which precedes the S field is used to indicate whether the request is for un-sharpening (U=1) or sharpening (U=0) a video image. As described above, the name field is used to identify the type of application dependent data that is associated with the packet. For the CCI APP report block, this value may be set to “CCI0” encoded in the ASCII format.

It should be noted that usage of the CCI should also be indicated in the offer/answer negotiation procedure described above to ensure that the other party understands any transmitted commands. This may be performed by introducing a new media level attribute to the session description protocol (SDP), which would indicate support for CCI. Such a media level attribute may have the following augmented Backus-Naur Form (ABNF) syntax:
CCI_Indication=“a=cci:1” CRLF

Alternatively, the new media level attribute can be defined to enable exact signaling of the supported CCI operations as follows:
CCI_Indication=“a=cci:” SP CCI_operation SP *(“;” CCI_operation) CRLF
CCI_operation=(“Pan”/“Tilt”/“HM”/“VM”/“Zoom”/“Sharpen”)

CCIs are transmitted to a remote party, e.g., the sending party (the video conference session participant that is transmitting the video stream) together with the RTCP receiver reports of the video stream of that camera. That is, CCI commands can be sent in-band within the RTCP stream from the receiving party to the sending party. An RTCP packet is composed of several blocks as described above, one of which is a session description (SDES) block that is mandatory. An RTCP APP packet for signaling the CCI commands can be appended to the RTCP packet. Sending the CCI commands can be opportunistic, i.e., together with the RTCP receiver reports, or the sending can be immediate, i.e., as a separate process where an RTCP packet is created and dedicated for sending the CCI commands.

Upon receiving one or more CCIs, the user equipment (UE), e.g., a mobile device having a camera, of the sending party (the video conference session participant that is transmitting the video stream), renders the extracted requests to the sending party. In accordance with one embodiment, a representation of the command may be overlayed on a UE screen of the mobile device utilized by the sending party.

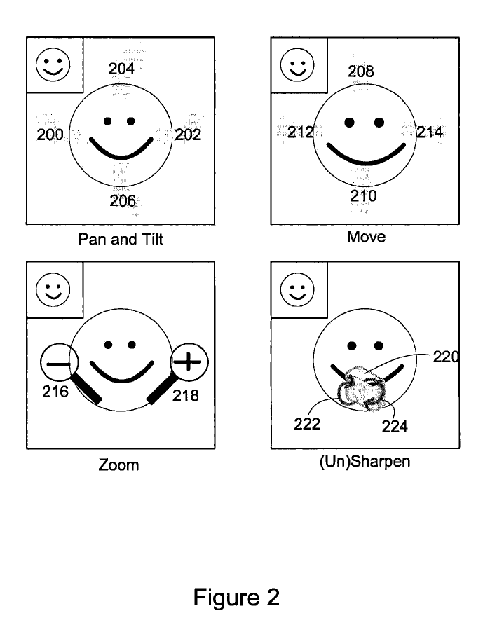

FIG. 2 illustrates various examples of this rendering in accordance with various embodiments. With regard to a pan and tilt CCI request, arrows are overlayed on a display used by or seen by the remote/receiving video conference session participant. Arrow 200 indicates that panning of, e.g., a mobile device camera, to the left is requested. Likewise, arrow 202 indicates that panning of the mobile device camera to the right is requested. Arrows 204 and 206 indicate that tilting of the mobile device camera up or down, respectively, is requested. As to a move CCI request, arrows 208 and 210 which are indicative of a request to move the mobile device camera up or down, respectively, can be overlayed on the display. Arrows 212 and 214 can be overlayed on the display of the mobile device when a request to move the mobile device camera left or right, respectively, is received. When zooming in or out is requested of the remote/receiving video conference session participant, a zoom out indication 216 may be overlayed on the display or a zoom in indication 218 may be overlayed on the display. If sharpening or unsharpening of a display is requested, some type of indicia can be overlayed on the display to notify the sending party that sharpening/unsharpening is being requested by a receiving party. In this case, a camera with a lens 220 is used as the indicia, although any graphic can be used. Additionally, arrows 222 and 224 are overlayed on the display in conjunction with the camera and lens indicia to indicate a request to sharpen or unsharpen the mobile device camera of the sending party.

Another way to render the received indications is by translating the CCIs into other types of signals or indicators, e.g., voice commands, sounds, vibration patterns, etc. However, the visual rendering is preferable as it does not disturb the course of the video conferencing session. As described above and in accordance with various embodiments, an interface may be provided to a receiving party so that the receiving party can input one or more desired CCI requests. Therefore, although FIG. 2 has been described above as being applicable to a sending party, the same or a similar system and method of overlaying indicia can be displayed to the receiving party as well. In other words, the same or substantially the same displays as those illustrated in FIG. 2 can be presented to the receiving party so that the receiving party may request CCIs via an interface using such visual indications. For example, the receiving party, using his/her mobile device, can “click” on arrow 214 which would result in a CCI request being sent to the sending party instructing the sending party to move his/her camera or mobile device to the right. Alternatively, a menu of commands/CCI requests, for example, can be displayed to the receiving party, where the receiving party can select one or more commands/CCI requests to be indicated to the sending party.

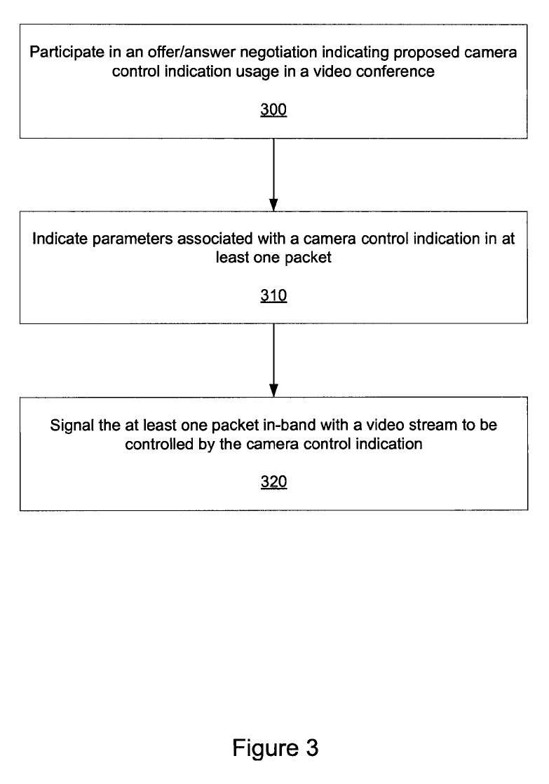

FIG. 3 is a flow chart illustrating processes performed to indicate camera control operations to a remote party in a video conference session in accordance with various embodiments. At 300, usage of camera control indications is proposed by participating in an offer/answer negotiation during a session setup process. At 310, parameters associated with a camera control indication are indicated in at least one packet. As described above, the at least one packet can be a CCI APP report block that is transmitted along with a RTCP receiver report. At 320, the at least one packet is signaled in-band with the video stream to be controlled by the camera control indication, i.e., the camera that at least in part, generates the video stream will be controlled in accordance with the camera control indication. It should be noted that more or less processes may be performed in accordance with various embodiments and that the order in which the processes described above operate may be altered.

When a user/receiving party desires to transmit a CCI request(s), the user presses a button associated with the desired CCI request that generates a specific command. Such buttons may be implemented as part of the interface described above. For example, hard keys or soft keys associated with CCI requests listed in a menu or associated with displayed indicia can be configured on the mobile device of the user. As long as a button is being pressed, the magnitude of a particular command is increased. For example, if the user wishes to transmit a CCI request to the sending party indicating a desire for the sending party to zoom in with his/her mobile device camera, the user presses a button associated with the zoom in CCI request. The longer the user presses the button, the greater the amount of requested zooming is indicated to the sending party. Conversely, if the user “taps” the button, a smaller amount of requested zooming is indicated to the sending party.

When the user releases a button, a protection period starts in accordance with various embodiments. The protection period is meant to give sufficient time for the remote/sending party to react to the received CCI. In order to ensure that the protection period is adhered to, the user interface may be configured to indicate further operation(s) is currently not possible during the protection period. This may be achieved by disabling the button(s) associated with the CCI requests/commands and displaying a timer, although it should be noted that various other methods of ensuring that the protection period is followed can be used in accordance with various embodiments. As soon as the protection period has elapsed, the user interface can indicate this to the receiving party, e.g., by enabling/re-enabling the button(s) in the user interface. Therefore, once the protection period has elapsed, the user/receiving party can request a new command. It should be noted that the protection period can have a default end time or the sending party may end the protection period at some time after execution of the requested CCI.

In case multiple session receiving participants are involved in a video conferencing session, various embodiments allow for the receiver of a command, e.g., the sending party, to reflect the received and performed operation (CCI request) in its own RTCP sender or receiver reports without changing the target SSRC/CSRC (i.e., the sending party as the source). Such a feature enables other participants of the video conference session to be aware of the received indication. Hence, other receiving parties can, e.g., refrain from sending similar CCI requests to a sending party for a given protection period.

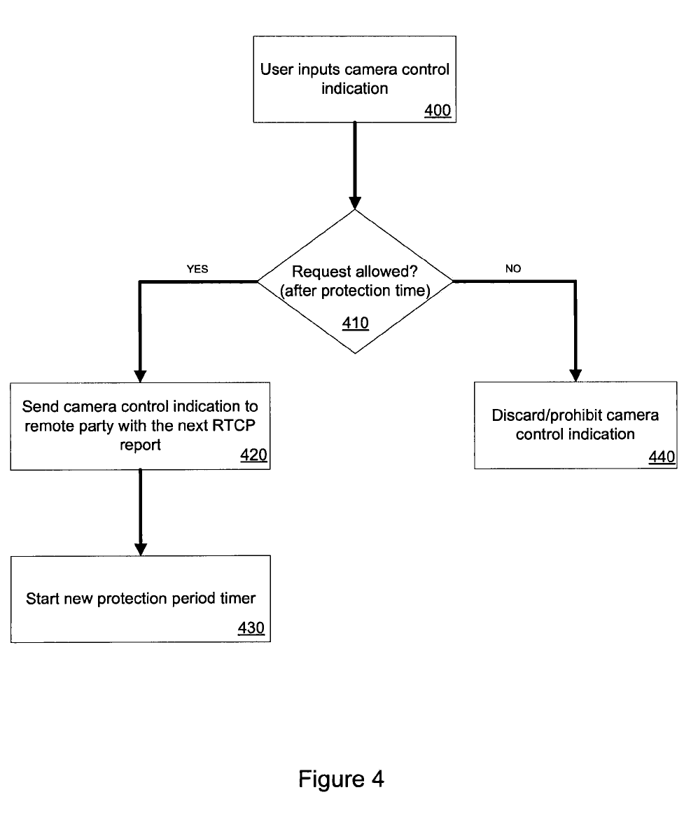

FIG. 4 illustrates processes performed in accordance with various embodiments for providing delay protection as described above. At 400, a user/receiving party inputs a camera control indication. At 410, a check is performed to determine whether the protection period has elapsed, and thus whether or not the camera control indication request is allowed. If the protection period has expired and the camera control indication request is allowed, the camera control indication is sent to a remote party (e.g., the sending party) with the next RTCP report at 420. At 430, a new protection period timer is set/re-started. If at 410, the protection period has not yet expired, the camera control indication is discarded or otherwise prohibited as described above at 440.

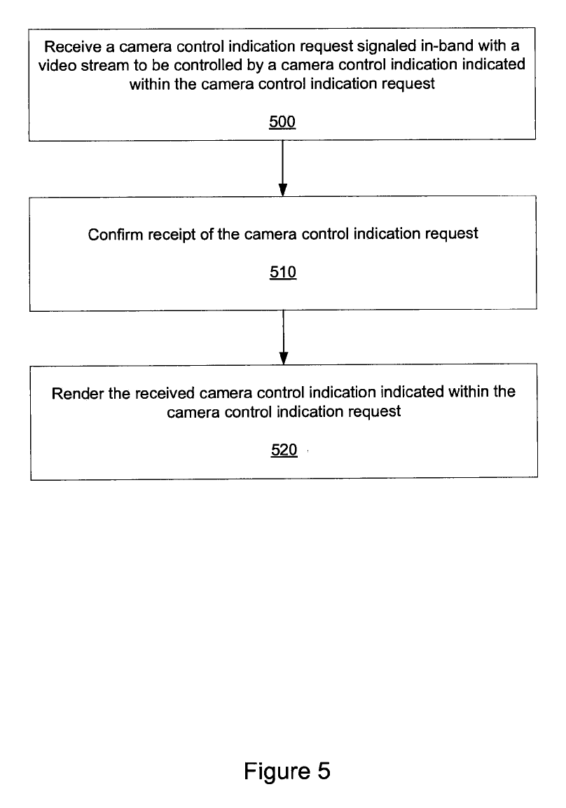

FIG. 5 is a flow chart illustrating processes performed when receiving camera control operations in accordance with various embodiments. At 500, a camera control indication request is received by a mobile device utilized by the sending party to effectuate a video conference. As described above, the camera control indication request is received in-band with RTCP receiver reports of the video stream of the camera of the sending party's mobile device. At 510, the mobile device confirms receipt of the camera control indication request. At 520, a camera control indication indicated within the camera control indication request is rendered on the sending party's mobile device display, e.g., visually, via audio, via vibration, etc. It should be noted that the order in which these processes are performed may differ in accordance with various embodiments. For example, the receipt confirmation may occur after the camera control indication has already been rendered. Moreover, more or less processes can be performed in accordance with various embodiments.

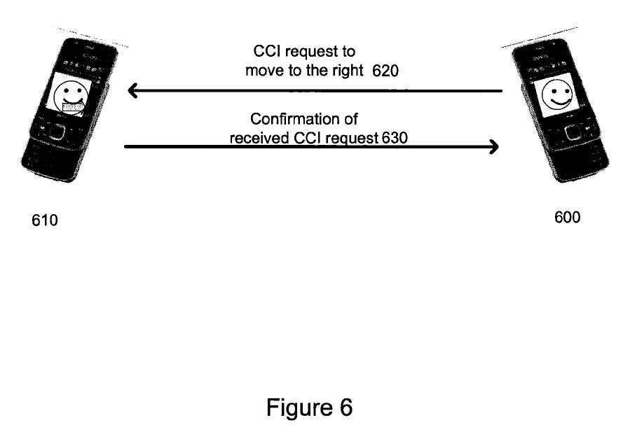

FIG. 6 illustrates an example scenario of a camera control indication message exchange during a video conference. Users of two mobile devices, such as mobile telephones 600 and 610 are engaged in a video conference, where each of the mobile telephones 600 and 610 have implemented therein, respective mobile device cameras. In this exemplary scenario, mobile telephone 600 is being utilized by a receiving party. That is, mobile telephone 600 is the recipient of a video stream from mobile telephone 610, which is being utilized by a sending party. The user of mobile telephone 600 may desire that certain adjustments be made with the mobile device camera of the mobile telephone 610, and the mobile telephone 600 is utilized to send a CCI request 620 to the user of the mobile telephone 610. In this scenario, the CCI request 620 refers to a request that the mobile device camera of the mobile telephone 610 be moved to the right. The mobile telephone 610 then receives the CCI request 620, whereupon a confirmation of the received CCI request 530 is returned to the mobile telephone 600. It should be noted that other possible scenarios may involve at least two devices, where one of the devices or neither of the devices is a mobile device such as a mobile telephone. For example, devices 600 and 610 may comprise a desktop computer, a personal digital assistant (PDA), a notebook computer, an integrated messaging device (IMD), etc.

Various embodiments disclosed herein describe a system and method for communicating CCIs to a remote party of a video conference in an efficient manner. Moreover, the input of the CCI requests as well as its rendering on, e.g., a mobile device, of the remote party are transparent to the video conference session and do not “disturb” other session participants.

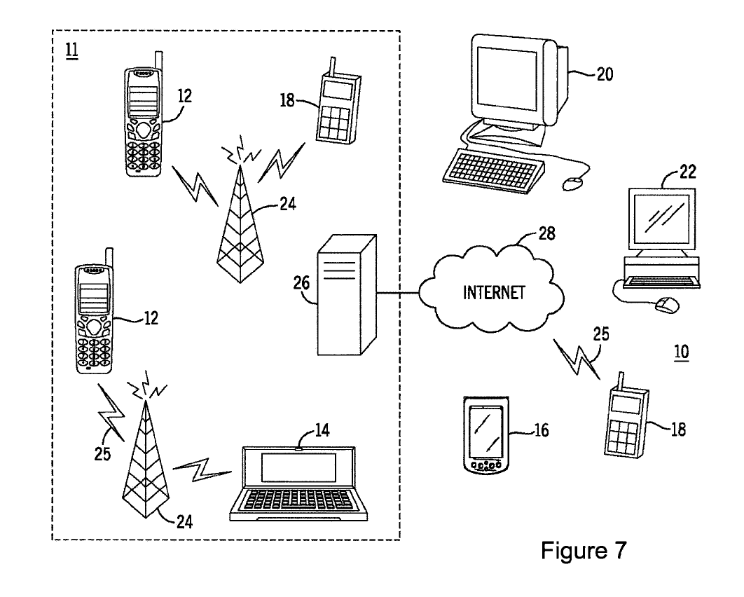

FIG. 7 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 7 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination PDA and mobile telephone 14, a PDA 16, an IMD 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 9 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

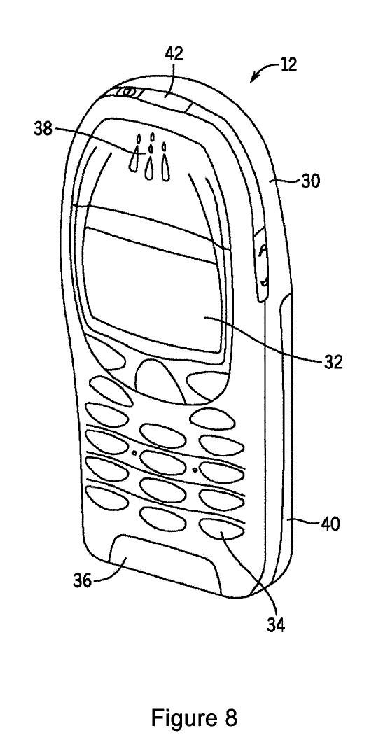

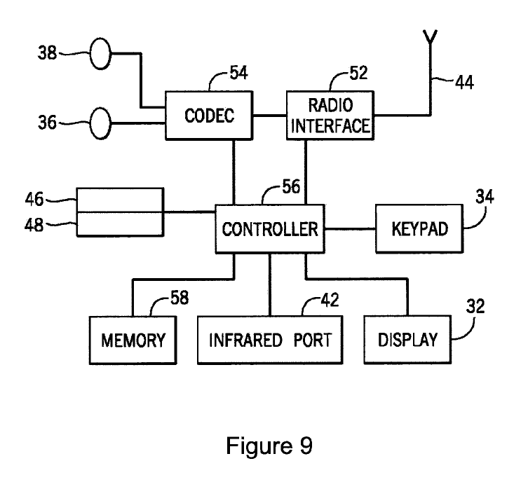

FIGS. 8 and 9 show one representative electronic device 12 within which various embodiments may be implemented. It should be understood, however, that various embodiments are not intended to be limited to one particular type of device. The electronic device 12 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit various embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize various embodiments and with various modifications as are suited to the particular use contemplated. The features of the embodiments described herein may be combined in all possible combinations of methods, apparatus, modules, systems, and computer program products.

What is claimed is:

1. A method, comprising:
participating in an offer and answer negotiation indicating proposed camera control indication usage in a video conference;
indicating parameters associated with a camera control indication in at least one packet; and
signaling the at least one packet in-band with a video stream to be controlled by the camera control indication.

2. The method of claim 1, wherein the at least one packet comprises an application-defined Real-Time Control Protocol report block.

3. The method of claim 1, wherein the signaling of the at least one packet is performed by one of transmitting the camera control indication request with a Real-Time Control Protocol receiver report of the video stream and transmitting the camera control indication request within a Real-Time Control Protocol packet of the video stream dedicated to transmitting the camera control indication request.

4. The method of claim 1, wherein the proposed camera control indication usage is indicated in a media level attribute to a session description protocol model.

5. The method of claim 1, wherein the parameters associated with the camera control indication comprise one of a panning magnitude operation, a tilting magnitude operation, a zooming magnitude operation, a horizontal motion request operation, a vertical motion request operation, and a sharpening operation.

6. The method of claim 5, wherein a preceding field within the at least one packet indicates a desired operating direction for at least one of the panning magnitude operation, the tilting magnitude operation, the zooming magnitude operation, the horizontal motion request operation, and the vertical motion request operation.

7. The method of claim 5, wherein a preceding field within the at least one packet indicates one of a desired sharpening effect and an unsharpening effect for the sharpening operation.

8. The method of claim 5 further comprising, providing a user interface allowing a user to indicate at least one of the panning magnitude operation, the tilting magnitude operation, the zooming magnitude operation, the horizontal motion request operation, the vertical motion request operation, and the sharpening operation.

9. The method of claim 1 further comprising, activating a protection period, wherein during the protection period, a subsequent camera control indication request is one of discarded and prohibited.

10. A computer program product comprising computer code, embodied on a computer-readable medium, configured to perform the processes of claim 1.

11. An apparatus, comprising:
an electronic device configured to:
participate in an offer and answer negotiation indicating proposed camera control indication usage in a video conference;
indicate parameters associated with a camera control indication in at least one packet; and
signal the at least one packet in-band with a video stream to be controlled by the camera control indication.

12. The apparatus of claim 11, wherein the at least one packet comprises an application-defined Real-Time Control Protocol report block.

13. The apparatus of claim 11, wherein the electronic device is configured to signal the at least one packet by one of transmitting the camera control indication request with a Real-Time Control Protocol receiver report of the video stream and transmitting the camera control indication request within a Real-Time Control Protocol packet of the video stream dedicated to transmitting the camera control indication request.

14. The apparatus of claim 11, wherein the proposed camera control indication usage is indicated in a media level attribute to a session description protocol model.

15. The apparatus of claim 11, wherein the parameters associated with the camera control indication comprise one of a panning magnitude operation, a tilting magnitude operation, a zooming magnitude operation, a horizontal motion request operation, a vertical motion request operation, and a sharpening operation.

16. The apparatus of claim 15, wherein a preceding field within the at least one packet indicates a desired operating direction for at least one of the panning magnitude operation, the tilting magnitude operation, the zooming magnitude operation, the horizontal motion request operation, and the vertical motion request operation.

17. The apparatus of claim 15, wherein a preceding field within the at least one packet indicates one of a desired sharpening effect and an unsharpening effect for the sharpening operation.

18. The apparatus of claim 15, wherein the electronic device is further configured to provide a user interface allowing a user to indicate at least one of the panning magnitude operation, the tilting magnitude operation, the zooming magnitude operation, the horizontal motion request operation, the vertical motion request operation, and the sharpening operation.

19. The apparatus of claim 11, wherein the electronic device is further configured to activate a protection period, wherein during the protection period, a subsequent camera control indication request is one of discarded and prohibited.

20. The apparatus of claim 11, wherein the electronic device comprises a mobile device having a camera.

21. A method, comprising:
receiving a camera control indication request signaled in-band with a video stream of a video conference to be controlled by a camera control indication indicated within the camera control indication request;
confirming receipt of the camera control indication request; and
rendering the received camera control indication.

22. The method of claim 21, wherein the camera control indication request is received from a video conference participant that is receiving the video stream.

23. The method of claim 21, wherein the camera control request is received within one of at least one packet comprising an application-defined Real-Time Control Protocol report block and at least one Real-Time Control Protocol packet of the video stream dedicated to transmitting the camera control indication request.

24. The method of claim 23, wherein the at least one packet is received with a Real-Time Control Protocol receiver report of the video stream.

25. The method of claim 21, wherein the camera control indication comprises one of a panning magnitude operation, a tilting magnitude operation, a zooming magnitude operation, a horizontal motion request operation, a vertical motion request operation, and a sharpening operation.

26. The method of claim 25, wherein the rendering of the camera control indication comprises overlaying graphical indicia indicative of one of the panning magnitude operation, the tilting magnitude operation, the zooming magnitude operation, the horizontal motion request operation, the vertical motion request operation, and the sharpening operation over a display of the video stream.

27. The method of claim 25, wherein the rendering of the camera control indication comprises translating the camera control indication into one of an audio and vibrational indicator.

28. A computer program product, comprising computer code, embodied on a computer-readable medium, configured to perform the processes of claim 21.

29. An apparatus, comprising:
an electronic device configured to:
receive a camera control indication request signaled in-band with a video stream of a video conference to be controlled by a camera control indication indicated within the camera control indication request;
confirm receipt of the camera control indication request; and
render the received camera control indication.

30. The apparatus of claim 29, wherein the camera control indication request is received from a video conference participant that is receiving the video stream.

31. The apparatus of claim 29, wherein the camera control request is received within one of at least one packet comprising an application-defined Real-Time Control Protocol report block and at least one Real-Time Control Protocol packet of the video stream dedicated to transmitting the camera control indication request.

32. The apparatus of claim 31, wherein the at least one packet is received with a Real-Time Control Protocol receiver report of the video stream.

33. The apparatus of claim 29, wherein the camera control indication comprises one of a panning magnitude operation, a tilting magnitude operation, a zooming magnitude operation, a horizontal motion request operation, a vertical motion request operation, and a sharpening operation.

34. The apparatus of claim 33, wherein the electronic device is configured to render the camera control indication by overlaying graphical indicia indicative of one of the panning magnitude operation, the tilting magnitude operation, the zooming magnitude operation, the horizontal motion request operation, the vertical motion request operation, and the sharpening operation over a display of the video stream.

35. The apparatus of claim 34, wherein the electronic device is configured to render of the camera control indication by translating the camera control indication into one of an audio and vibrational indicator.

36. An apparatus, comprising:
means for participating in an offer and answer negotiation indicating proposed camera control indication usage in a video conference;
means for indicating parameters associated with a camera control indication in at least one packet; and
means for signaling the at least one packet in-band with a video stream to be controlled by the camera control indication.

37. An apparatus, comprising:
means for receiving a camera control indication request signaled in-band with a video stream of a video conference to be controlled by a camera control indication indicated within the camera control indication request;
means for confirming receipt of the camera control indication request; and
means for rendering the received camera control indication.
